(19) United States
(12) Patent Application Publication
(10) Pub. No.: US 2026/0105274 A1
(43) Pub. Date: Apr. 16, 2026

(54) Method of using Confidence Metrics for Data Code Scoring and Auto-tune

(71) Applicant: ZEBRA TECHNOLOGIES CORPORATION, Lincoinshire, IL (US)

(72) Inventor: Michal Czardybon, Gilwice (PL)

(21) Appl. No.: 18/915,277

(22) Filed: Oct. 14, 2024

(51) Int. Cl. G06K 7/14

(52) U.S. Cl. CPC G06K 7/146

(57) ABSTRACT

A method for performing confidence scoring of an imaging system. The method includes an imaging system obtaining an image of a field of view of the imaging system with the image including an indicia. A processor identifies the indicia in the image and decodes the indicia. The processor further determines one or more confidence parameters from at least one of (i) the image of the indicia, and (ii) the decoding of the indicia. The processor then determines a confidence rating from the one or more confidence parameters. The method may further include tuning one or more parameters of the imaging system, or of reading and decoding processes and systems for decoding the indicia.

### BACKGROUND OF THE INVENTION

Devices such as barcode scanners are used in various inventory applications. Barcode scanners are typically capable of efficiently reading and decoding barcodes in a given environment for given illuminations and for specific types of barcodes. Barcode systems may not be capable of reading different types of barcodes (e.g., printed paper barcodes vs. 3D printed plastic barcodes) or capable of reading barcodes in different environments. Additionally, the quality of a barcode may vary across applications or between barcodes. For example, a given barcode may be positioned such that it receives less illumination than a subsequent barcode, or a barcode may include smudges or be ripped which obscures some of the barcode resulting in the inability to read a barcode. As such, systems may not be able to efficiently read barcodes given the specific environment and physical conditions of individual barcodes. Typical barcode readers do not typically provide feedback to users for improving reading and decoding of barcodes based on the described scenarios.

Accordingly, there is a need for identifying and providing information pertaining to the ability to image and decode barcodes, to improve indicia decoding efficiencies of imaging capture systems such as barcode readers.

### SUMMARY

In an embodiment, the present invention is a method for performing confidence scoring of an imaging system. The method includes obtaining, by the imaging system, an image of a field of view of the imaging system, the image including an indicia; identifying, by a processor, the indicia in the image; decoding, by the processor, the indicia; determining, by the processor, one or more confidence parameters from at least one of (i) the image of the indicia, and (ii) the decoding of the indicia; determining, by the processor, a confidence rating from the one or more confidence parameters.

In a variation of this embodiment, the method may further include tuning one or more parameters of the system according to the determined confidence parameter. In examples of the current variation, the one or more parameters of the system comprises at least one of an imaging parameter of the imaging system, an illumination parameter, a pre-decoding module parameter, and a decoding parameter. Examples of the one or more parameters of the system may include one or more of an imaging resolution, lens focus setting, an image capture rate, an image capture exposure time, an image gain, an illumination brightness, a decode rate, and a decode time-out.

In variations of the current embodiment, the confidence score comprises values from 0 to 1, with a value of 1 being indicative of high confidence, and a value of 0 being indicative of low confidence, the confidence score may have a negative value indicative of a no read state wherein the system is incapable of decoding the indicia, and further, an absolute value of the negative value may be indicative of a distance of the system from reading the indicia.

In another embodiment, the present invention is a system for performing confidence scoring of indicia reading. The system includes an imaging assembly having an imaging sensor configured to capture images of a field of view of the imaging assembly, and one or more processors and machine-readable instructions stored on a memory. When executed by the one or more processors, the machine readable instructions cause the system to: obtain, by the imaging system, an image of a field of view of the imaging system, the image including an indicia; identify, by a processor, the indicia in the image; decode, by the processor, the indicia; determine, by the processor, one or more confidence parameters from at least one of (i) the image of the indicia, and (ii) the decoding of the indicia; determine, by the processor, a confidence rating from the one or more confidence parameters.

In a variation of this embodiment, the machine-readable instructions may further cause the system to tune one or more parameters of the system according to the determined confidence parameter. In examples of the current variation, the one or more parameters of the system comprises at least one of an imaging parameter of the imaging system, an illumination parameter, a pre-decoding parameter, and a decoding parameter. Examples of the one or more parameters of the system may include one or more of an imaging resolution, an image capture rate, an image capture exposure time, an image gain, an illumination brightness, a decode rate, and a decode time-out.

In variations of the current embodiment, the confidence score comprises values from 0 to 1, with a value of 1 being indicative of high confidence, and a value of 0 being indicative of low confidence, the confidence score may have a negative value indicative of a no read state wherein the system is incapable of decoding the indicia, and further, an absolute value of the negative value may be indicative of a distance of the system from reading the indicia.

In yet another embodiment, the present invention one or more non-transitory computer-readable media storing computer-executable instructions that, when executed via one or more processors, cause one or more systems to: obtain, by the imaging system, an image of a field of view of the imaging system, the image including an indicia; identify, by a processor, the indicia in the image; decode, by the processor, the indicia; determine, by the processor, one or more confidence parameters from at least one of (i) the image of the indicia, and (ii) the decoding of the indicia; determine, by the processor, a confidence rating from the one or more confidence parameters.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of an example imaging system configured to analyze an image of a target object to confidence rating evaluation and tuning of a system, in accordance with various embodiments disclosed herein.

FIG. 2 is a side view block diagram of a first embodiment of the imaging device of FIG. 1, in accordance with embodiments described herein.

FIG. 3 is a perspective view of a second embodiment of the imaging device of FIG. 1 that may be implemented in accordance with embodiments described herein.

FIG. 4 illustrates a perspective view of another imaging device as a scanning station, in accordance with an embodiments described herein.

FIG. 5 illustrates a scanning station imaging reader as an imaging device for performing the methods according to embodiments described herein.

FIG. 6 is a flowchart representative of a method for performing confidence rating based evaluation and tuning of a system, according to embodiments described herein.

FIG. 7A is an image of an example indicia as a data matrix code illustrating elements of the data matrix code for determining a finder score, in accordance with embodiments described herein.

FIG. 7B is an image of an example indicia as a data matrix code illustrating elements of the data matrix code for determining an alignment score, in accordance with embodiments described herein.

FIG. 7C is an image of an example indicia as a data matrix code illustrating elements of the data matrix code for determining a shape score, in accordance with embodiments described herein.

FIG. 7D is an image of an example indicia as a data matrix code illustrating elements of the data matrix code for determining a fixture score, in accordance with embodiments described herein.

FIG. 7E is an image of an example indicia as a data matrix code illustrating elements of the data matrix code for determining a timing score, in accordance with embodiments described herein.

FIG. 7F is an image of an example indicia as a data matrix code illustrating elements of the data matrix code for determining a texture score, in accordance with embodiments described herein.

FIG. 7G is an image of an example indicia as a data matrix code illustrating elements of the data matrix code for determining a decode score, in accordance with embodiments described herein.

FIG. 8A is an image of a data matrix code for determining a confidence rating according to embodiments described herein.

FIG. 8B presents a table of scores for different confidence parameters for the data matrix code of FIG. 8A.

FIG. 9A is an image of a data matrix code for determining a confidence rating according to embodiments described herein.

FIG. 9B presents a table of scores for different confidence parameters for the data matrix code of FIG. 9A.

FIG. 10A is an image of a data matrix code for determining a confidence rating according to embodiments described herein.

FIG. 10B presents a table of scores for different confidence parameters for the data matrix code of FIG. 10A.

FIG. 11A is an image of a data matrix code for determining a confidence rating according to embodiments described herein.

FIG. 11B presents a table of scores for different confidence parameters for the data matrix code of FIG. 11A.

FIG. 12A is an image of a data matrix code for determining a confidence rating according to embodiments described herein.

FIG. 12B presents a table of scores for different confidence parameters for the data matrix code of FIG. 12A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Barcode scanners and indicia readers are convenient for quickly and efficiently identifying targets and objects for various applications such as purchasing items, performing inventory tasks, monitoring and categorizing merchandise, stocking or monitoring warehouse inventory, performing data entry, and other uses. However, barcode scanning systems may fail, or operate inefficiently for any number of reasons including insufficient, or too much, illumination, imaging system limitations, barcode print errors, etc. Typical systems do not provide any means for identifying one or more reasons for barcode scanning errors and inefficiencies, and therefore may not be capable of identifying and decoding different types of barcodes in various environments and conditions. The proposed system and methods allow for the evaluation of performing decoding of indicia via images captured by an imaging assembly. The confidence score is based on a number of determined confidence parameters indicative of different aspects of performing the decoding (e.g., image quality, decode time, pre-decode processing of image, etc.). The disclosed confidence rating based approach allows for the system to identify different parameters of components (e.g., imaging system resolution, illumination brightness, image pre-processing parameters, etc.) that many be tuned to improve the efficiency of reading a barcode. Further, the confidence score may allow the system to identify and tune system parameters to enable reading of a barcode that was previously unable to be read and decoded.

The disclosed system and methods propose an imaging assembly with one or more imaging sensor configured to capture images of a field of view of the imaging assembly. The system further includes one or more processors and machine-readable instructions stored on a memory. When executed by the one or more processors the machine-readable instructions cause the system to obtain, via the imaging assembly, images of the field of view of the imaging assembly. The images include one or more target objects for identifying indicia associated with the target objects. A processor then identifies one or more indicia in the image, and further decodes the indicia. The processor then further determines one or more confidence parameters from the image of the indicia, or from decoding of the indicia. The confidence parameters may include various parameters associated with the image, the imaging assembly, the processor, any pre-decoding processes (e.g., image reshaping, image transformations, indicia identifying algorithms, etc.), and the decoding of the indicia. The processor then determines a confidence rating from the confidence parameters, and specifically from scores associated with the various confidence parameters.

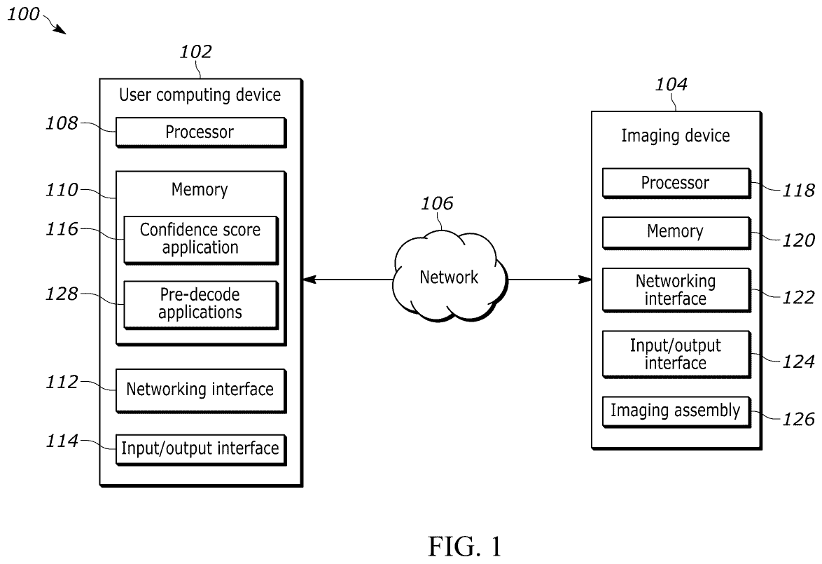

Referring now to the drawings, FIG. 1 illustrates an example imaging system 100 configured to analyze an image of a target object to decode indicia and perform confidence score-based analysis and system autotuning, in accordance with various embodiments disclosed herein. The imaging system 100 is configured to capture images of objects, decode indicia in the images, and further determine confidence scores based on the images, pre-decoding, and decoding processes. The system 100 may be used for performing inventory analysis, in point-of-sale systems, in data entry, etc. In the example embodiment of FIG. 1, the imaging system 100 includes a user computing device 102 and an imaging device 104 communicatively coupled via a network 106. The user computing device 102 may include one or more processors 108, one or more memories 110, a networking interface 112, an input/output (I/O) interface 114, a confidence score application 116, and a pre-decode application 128. The user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to create a machine vision task, indicia scanning task, or confidence score evaluation for execution on the imaging device 104. In examples, the imaging device 104 may utilize machine vision techniques to analyze captured images and execute a task. In other examples, the imaging device 104 may capture images and provide the images to another device such as a network, or processor, which may analyze the images and perform a machine vision task for image processing. When created, the user/operator may then transmit/upload the machine vision task, or decoding based task to the imaging device 104 via the network 106, where the machine vision task is then interpreted and executed. In examples described herein, the machine vision task may include performing various imaging techniques for scanning and decoding of indicia.

The imaging device 104 is connected to the user computing device 102 via a network 106, and is configured to interpret and execute tasks received from the user computing device 102. Generally, the imaging device 104 may obtain a task file containing one or more task scripts from the user computing device 102 across the network 106 that may define the machine vision task and may configure the imaging device 104 to capture and/or analyze images in accordance with the task. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more task scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically obtain, interpret, and execute task scripts that define machine vision tasks, such as any one or more task scripts contained in one or more task files as obtained, for example, from the user computing device 102. In examples, the imaging device 104 may be a handheld device that a user controls to capture one or more images of a target at one or more perspectives of the target for further processing of the images and for reconstruction of one or more features or dimensions of the target.

Broadly, the task file may be a JSON representation/data format of the one or more task scripts transferrable from the user computing device 102 to the imaging device 104. The task file may further be loadable/readable by a C++ runtime engine, or other suitable runtime engine, executing on the imaging device 104. Moreover, the imaging device 104 may run a server (not shown) configured to receive task files across the network 106 from the user computing device 102. Additionally or alternatively, the server configured to receive task files may be implemented as one or more cloud-based servers, such as a cloud-based computing platform. For example, the server may be any one or more cloud-based platform(s) such as MICROSOFT AZURE, AMAZON AWS, or the like.

The imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data, voxel data, vector information, or other image data that may be analyzed by one or more tools each configured to perform an image analysis task. The digital camera and/or digital video camera of, e.g., the imaging assembly 126 may be configured, as disclosed herein, to take, capture, obtain, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be a red, green blue (RGB) based camera for capturing 2D images having RGB-based pixel data. In various embodiments, the imaging assembly may additionally include a 3D camera (not shown) for capturing, sensing, or scanning 3D image data. The 3D camera may include an Infra-Red (IR) projector and a related IR camera for capturing, sensing, or scanning 3D image data/datasets. Other 3D cameras may be used for the described methods such as projectors, lasers, time of flight sensors and systems, and/or structured light-based detection systems, among other systems and devices capable of capturing 3D data from one or more FsOV. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. As such, the captured 2D images and the corresponding 2D image data may be depth-aligned with the 3D images and 3D image data.

In embodiments, the imaging assembly 126 may be configured to capture images of surfaces or areas of a predefined search space or target objects within the predefined search space. For example, each tool included in a task script may additionally include a region of interest (ROI) corresponding to a specific region or a target object imaged by the imaging assembly 126. The ROI may be a predefined ROI, or the ROI may be determined through analysis of the image by the processor 118. Further, a plurality of ROIs may be predefined or determined through image processing. The composite area defined by the ROIs for all tools included in a particular task script may thereby define the predefined search space which the imaging assembly 126 may capture to facilitate the execution of the task script. However, the predefined search space may be user-specified to include a field of view (FOV) featuring more or less than the composite area defined by the ROIs of all tools included in the particular task script. The imaging assembly 126 may be configured to identify predefined objects or physical features for reconstruction of a target or dimensions of a target. For example, the imaging assembly 126 may be configured to identify a cuboid, or features of a cuboid (e.g., vertices, edge lines, surfaces, etc.) of a box or parcel for further processing to determine a size or other dimension of one or more features of the cuboid. The ROI may be defined as a region of an image or target object that includes an indicia for identifying the indicia, and decoding of the indicia according to the methods described herein.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the pre-decode application 128 and the confidence score application 116 for determining a confidence score based on the image data, post-imaging data, pre-decoding processes, and decoding of indicia in the image. Further, the confidence score application may further provide the image, or post-imaging data, along with associated confidence parameter values and confidence score for viewing, additional processing, and/or otherwise interaction. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., and a pre-decode application 128, and confidence score application 116, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120 may store an operating system (OS) (e.g., Microsoft Windows, Linux, Unix, etc.) capable of facilitating the functionalities, apps, methods, or other software as discussed herein. The one or more memories 110 may also store the and pre-decode application 128 and confidence score application 116, which may be configured to enable machine vision task construction, as described further herein. Additionally, or alternatively, the pre-decode application 128 and confidence score application 116 may also be stored in the one or more memories 120 of the imaging device 104, and/or in an external database (not shown), which is accessible or otherwise communicatively coupled to the user computing device 102 via the network 106. The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision-based imaging application, where each may be configured to facilitate their various functionalities discussed herein. It should be appreciated that one or more other applications may be envisioned and may be executed by the one or more processors 108, 118.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision task images (e.g., images captured by the imaging device 104 in response to execution of a task script) and/or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally or alternatively, network 106 may comprise a public network such as the Internet. In some embodiments, the network 106 may comprise routers, wireless switches, or other such wireless connection points communicating to the user computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102 and/or the imaging device 104. According to some embodiments, an administrator or user/operator may access the user computing device 102 and/or imaging device 104 to construct tasks, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

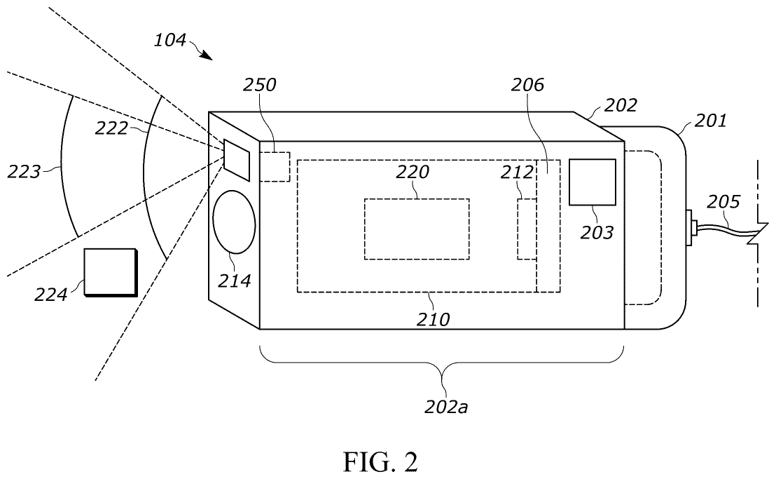

Three embodiments of imaging devices for performing confidence score determination and confidence score-based tuning, as described herein, are shown in schematics in FIGS. 2-4. Referring now to FIG. 2, the imaging device 104 includes a housing 202, an illumination system 250, and an imaging system 210 at least partially disposed within the housing 202 that includes an imaging camera assembly. Specifically, the imaging system 210 includes an image sensor 212 and a lens assembly 220. The device 104 may be adapted to be inserted into a docking station 201 which, in some examples, may include an AC power source 205 to provide power for the device 104. The device 104 may further include an onboard power supply 203, such as a battery and a printed circuit board 206 that may accommodate a memory and a controller that controls operation of the imaging system 210. In embodiments, the device 104 may include a trigger (not shown in the illustration) that is used to activate the imaging system 210 to capture an image. The device 104 may include any number of additional components such as decoding systems, processors, and/or circuitry coupled to the circuit board 206 to assist in operation of the device 104.

The housing 202 includes a forward or reading head portion 202a which supports the imaging system 210 within an interior region of the housing 202. The imaging system 210 may, but does not have to be, modular as it may be removed or inserted as a unit into the devices, allowing the ready substitution of illumination systems 250 and/or imaging systems 210 having different illumination and/or imaging characteristics (e.g., illumination systems having different illumination sources, lenses, illumination filters, illumination FOVs and ranges of FOVs, camera assemblies having different focal distances, working ranges, and imaging FOVs) for use in different devices and systems. In some examples, the field of view may be static.

The image sensor 212 may have a plurality of photosensitive elements forming a substantially flat surface and may be fixedly mounted relative to the housing 202 using any number of components and/or approaches. The image sensor 212 further has a defined central imaging axis, A, which is normal to the substantially flat surface. In some embodiments, the imaging axis A is coaxial with a central axis of the lens assembly 220. The lens assembly 220 may also be fixedly mounted relative to the housing 202 using any number of components and/or approaches. In the illustrated embodiment, the lens assembly 220 is positioned between a front aperture 214 and the image sensor 212. The front aperture 214 blocks light from objects outside of the field of view which reduces imaging problems due to stray light from objects other than the target object. Additionally, the front aperture 214 in conjunction with a one or more lenses allows for the image to form correctly on the imaging sensor 212. The imaging device 104 has a FOV 223 of the imaging sensor to capture images of target objects and indicia in the FOV 223.

The housing 202 includes an illumination system 250 configured to illuminate a target object of interest for imaging of the target. The target may be a 1D barcode, 2D barcode, data matrix code, QR code, Universal Product Code (UPC) code, or another indicia indicative of the object of interest such as alphanumeric characters or other indicia. Additionally, the target may include one or more boxes, vehicles, rooms, containers, objects, or cuboid parcels, and the imaging system 250 may be configured to capture a color image or infrared image of the one or more targets. The illumination system 250 may provide illumination to an illumination FOV 222 to enable or assist with imaging a target 224.

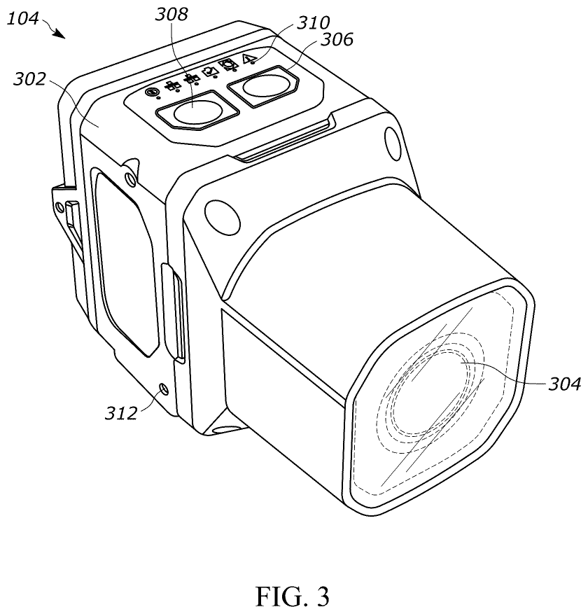

FIG. 3 is a perspective view of a second embodiment of an imaging device 104 that may be implemented in accordance with embodiments described herein. The imaging device 104 includes a housing 302, an imaging aperture 304, a user interface label 307, a dome switch/button 308, one or more light emitting diodes (LEDs) 311, and mounting point(s) 313. As previously mentioned, the imaging device 104 may obtain task files from a user computing device (e.g., user computing device 102) which the imaging device 104 thereafter interprets and executes. The instructions included in the task file may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 304. As an example, assume that at least a portion of the intended analysis corresponding to a machine vision task requires the imaging device 104 to maximize the brightness of any captured image. To accommodate this requirement, the task file may include device configuration settings to increase the aperture size of the imaging aperture 304. The imaging device 104 may interpret these instructions (e.g., via one or more processors 118) and accordingly increase the aperture size of the imaging aperture 304. Thus, the imaging device 104 may be configured to automatically adjust its own configuration to optimally conform to a particular machine vision task. Additionally, the imaging device 104 may include or otherwise be adaptable to include, for example but without limitation, one or more bandpass filters, one or more polarizers, one or more waveplates, one or more DPM diffusers, one or more C-mount lenses, and/or one or more C-mount liquid lenses over or otherwise influencing the received illumination through the imaging aperture 304.

The user interface label 307 may include the dome switch/button 308 and one or more LEDs 311, and may thereby enable a variety of interactive and/or indicative features. Generally, the user interface label 307 may enable a user to trigger and/or tune the imaging device 104 (e.g., via the dome switch/button 308) and to recognize when one or more functions, errors, and/or other actions have been performed or taken place with respect to the imaging device 104 (e.g., via the one or more LEDs 311). For example, the trigger function of a dome switch/button (e.g., dome/switch button 308) may enable a user to capture an image using the imaging device 104 and/or to display a trigger configuration screen of a user application. The trigger configuration screen may allow the user to configure one or more triggers for the imaging device 104 that may be stored in memory (e.g., one or more memories 110, 120) for use in later developed machine vision tasks, as discussed herein. The imaging device 104 may be a portable imaging device that a user may move around a target to obtain images at different perspectives of the target. The different perspectives may be considered to be taken at different fields of view of the imaging device 104. The imaging device 104 may have a single field of view but the perspective of the target may change based on the position and orientation of the imaging device 104 and corresponding field of view. In examples, a system may employ an imaging device having multiple fields of view with each field of view having a different spatial perspective of a target. As such, the imaging device may obtain multiple images of the target at different perspectives corresponding to the different fields of view of the imaging device. In more examples, a system may employ multiple imaging devices 104 with each imaging device 104 having a respective field of view with each field of view having a different perspective of a target. Therefore, each of the imaging devices may obtain an image at a different perspective for performing the methods described herein.

As another example, the tuning function of a dome switch/button (e.g., dome/switch button 308) may enable a user to automatically and/or manually adjust the configuration of the imaging device 104 in accordance with a preferred/predetermined configuration and/or to display an imaging configuration screen of a user application (e.g., confidence score application 116). The imaging configuration screen may allow the user to configure one or more configurations of the imaging device 104 (e.g., aperture size, exposure length, etc.) that may be stored in memory (e.g., one or more memories 110, 120) for use in later developed machine vision tasks, as discussed herein.

To further this example, and as discussed further herein, a user may utilize the imaging configuration screen to establish two or more configurations of imaging settings for the imaging device 104. The user may then save these two or more configurations of imaging settings as part of a machine vision task that is then transmitted to the imaging device 104 in a task file containing one or more task scripts. The one or more task scripts may then instruct the imaging device 104 processors (e.g., one or more processors 118) to automatically and sequentially adjust the imaging settings of the imaging device 104 in accordance with one or more of the two or more configurations of imaging settings after each successive image capture.

The mounting point(s) 313 may enable a user connecting and/or removably affixing the imaging device 104 to a mounting device (e.g., imaging tripod, camera mount, etc.), a structural surface (e.g., a warehouse wall, a warehouse ceiling, scanning bed or table, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 313 may enable a user to connect the imaging device 104 to a myriad of accessory items including, but without limitation, one or more external illumination devices, one or more mounting devices/brackets, and the like.

In addition, the imaging device 104 may include several hardware components contained within the housing 302 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

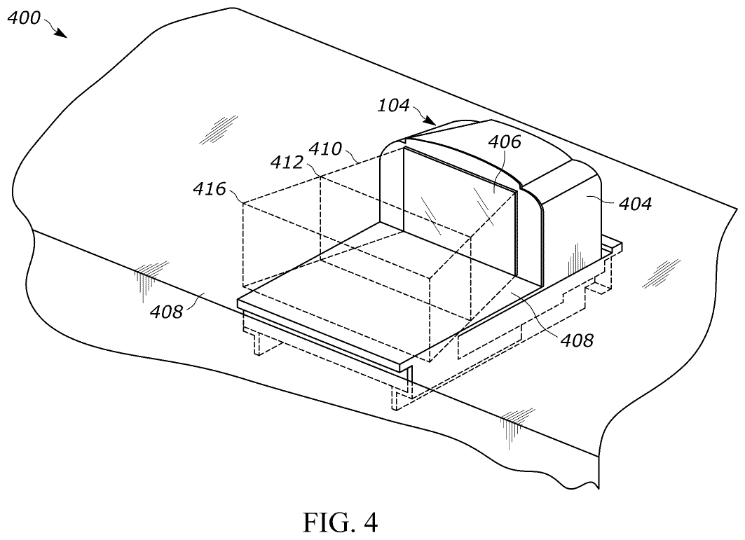

FIG. 4 illustrates an exemplary scanning station 300 having an imaging device 102, in the form of a bioptic scanner, having a housing 404 and a first scanning window 406 behind which is an illumination source (not shown) and an imaging stage with a field of view (not shown) like that of FIG. 2. The imaging reader 402 is positioned adjacent a scanning surface 408 and defines a horizontally and vertically extending working range 410 illuminated by the imaging device 102 and having defined imaging planes 412, and 416 at which the imaging device 102 captures images of an object for performing imaging, decoding indicia in the images, and determining confidence scores as described herein. The example imaging devices of FIGS. 2-4 are illustrative, and other imaging assemblies and systems may be used for performing the disclosed methods.

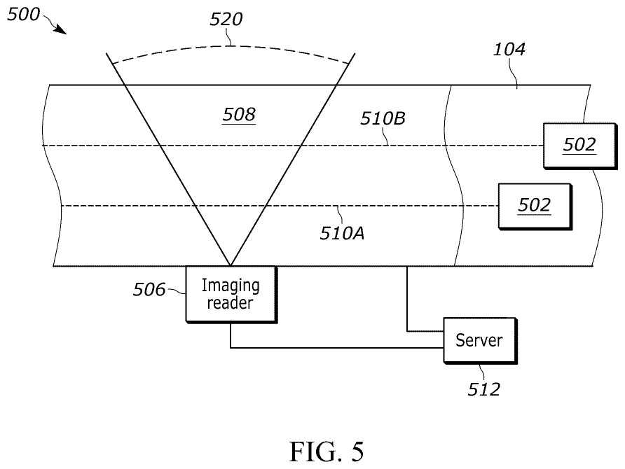

FIG. 5 illustrates an exemplary environment where embodiments of the present invention may be implemented, including the processes described and illustrated herein. In the present example, the environment is provided in the form of a scanning station 500 where goods 502 are moved across or along a scanning surface 504 and are scanned by an imaging reader 506 to identify the goods 502. In some embodiments, the scanning station is a point-of-sale (POS) station, which may have a computer system and an interface, not shown, for optically scanning goods and identifying the goods and characteristics of the goods for affecting a transaction. In some embodiments, the scanning station 500 is part of an inventory delivery system, where goods are conveyed by the scanning surface or across the scanning surface to monitor and control delivery of the goods, for example, shipping goods from a facility or receiving shipped goods to a facility.

The scanning surface 504 may be a stationary surface, such that the goods 502 are manually moved relative to the surface 504. In embodiments, the scanning surface 504 may move the goods 502 or be moved by another automated means. In other embodiments, the scanning surface 504 may be a moving surface, such as by a conveyor system such as a conveyer belt, pneumatic conveyer, wheel conveyer, roller conveyer, chain conveyer, flat conveyer, vertical conveyer, trolley conveyer, or another conveyer. In any case, the goods 502 may be moved continuously relative to the imaging reader 506, such that the goods 502 are constantly moving through a working (or scanning) range 508 of the station 500, within a field of view 520 of the imaging reader 506. In some examples, the goods 502 move in a discretized manner, where, at least part of the time the goods 502 are maintained fixed on the surface 504 relative to the imaging reader 506 for a period of time, sufficient to allow one or more images to be captured of the goods 502.

The goods 502 may move along different substantially linear paths 510A, 510B, etc. each path traversing the working range 508 but at a different distance from, and through the FOV 520 of, the imaging reader 506. Indeed, the paths 510A, 510B are for illustration purposes, as the goods 502 may traverse across the surface 504 at any distance from the imaging reader 506. While, in FIG. 1, the imaging reader 506 is depicted as being to the side of the goods 502, in embodiments, the imaging reader 506 may be positioned directly above the goods 502, above the goods 502 in front of or behind the goods 502 configured to image the OOI, or at another position for imaging a region of interest of the goods 502 or any OOI.

FIG. 6 illustrates a method 600 of performing confidence scoring for evaluating and improving indicia reading of an imaging system. The method 600 may be implemented using an imaging system or device, such as the system 100, and imaging devices 104 and imaging reader 506 of FIGS. 1-5. In the example of a handheld scanner, initially, the imaging reader enters a hands-free mode indicating that swipe scanning is to be performed. In some examples, the handheld scanner includes a trigger on or near a handle, and the trigger, when depressed, enters the scanner into the hands-free mode for swipe scanning. In some embodiments, the imaging scanner is part of a scanning station of an inventory system, where goods are conveyed by the scanning surface or across the scanning surface to monitor and control delivery of the goods, for example, shipping goods from a facility or receiving shipped goods to a facility. Further, the methods described herein may be implemented with an imaging reader being an inspection station where on OOI moves into a FOV of the scanner and continuous through and out of the FOV, or the OOI pauses momentarily in the field of view to be imaged, and then the OOI moves out of the field of view.

For simplicity the method 400 will be described in reference to components of FIGS. 1 and 2, but it should be understood that the method 400 may be performed for any imaging system for scanning a target or object of interest. The imaging device 104 obtains an image of one or more indicia in a FOV of the imaging device 104 at 602. The image may be captured by an imaging system including an imaging device such as the imaging devices 104 of FIGS. 1-4, or by another camera or imaging device or system. The imaging device captures an image of a FOV of the imaging device 104, with one or more targets, or objects of interest, being disposed in the FOV of the imaging device. The one or more target objects include one or more indicia, such as barcodes, indicative of information of properties associated with the one or more objects. In examples, the imaging system may include one or more of an infrared camera, a color camera, two-dimensional camera, a three-dimensional camera, a handheld camera, or a plurality of cameras.

At 604, a processor, such as the processor 118 of the imaging device 104, or the processor 108 of the computing device 102, identifies one or more indicia in the image. The processor may determine the indicia to include one or more of 1D or 2D barcodes, QR codes, UPC codes, alphanumeric codes, a serial number, a static QR code, a dynamic QR code, or other identifying indicia. The indicia may be indicative of one or more parameters or information associated with one or more target objects.

At 606, one or more processors may perform pre-decoding processing. The pre-decoding processing may include image processing for improving an image to perform decoding of indicia, or for altering the image data to perform decoding of the indicia. For example, the pre-decode processing may include performing sharpening of an image, or increasing the brightness of an image to increase the efficiency, or ability of a decoder for decoding of indicia in the image. Further, the pre-decoding processing may include image transformations such as skewing, stretching, rotating, resizing, cropping one or more geometric transformations, and other image processes and transformations for preparing the image, and specifically indicia contained in the image, for decoding. Further, the pre-decoding processing may further include object detection, indicia detection and identification, object or indicia alignment, image correction, image distortion etc. After the pre-decode processing is performed, the one or more processor further decodes the indicia at 608. In decoding the indicia, the processors may further identify one or more properties, or data associated with the target objects from the decoded indicia.

At 608, one or more processors determines and evaluates one or more confidence parameters from the image of the indicia, and/or the decoding of the indicia. The confidence parameters include various metrics associated with a quality of image, quality of imaged indicia, ability of system to decode the indicia, etc. that may be used for evaluating the overall efficiency, and ability of the system to decode indicia. In determining and evaluating the confidence parameters, the processors may assign values to each confidence parameter indicative of a performance or quality of each respective confidence parameter.

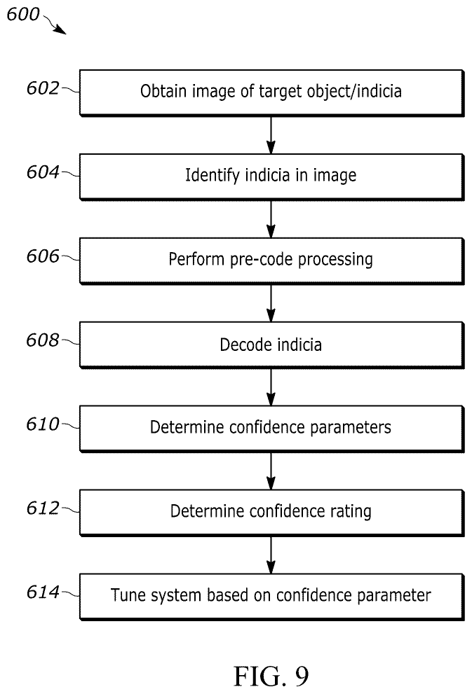

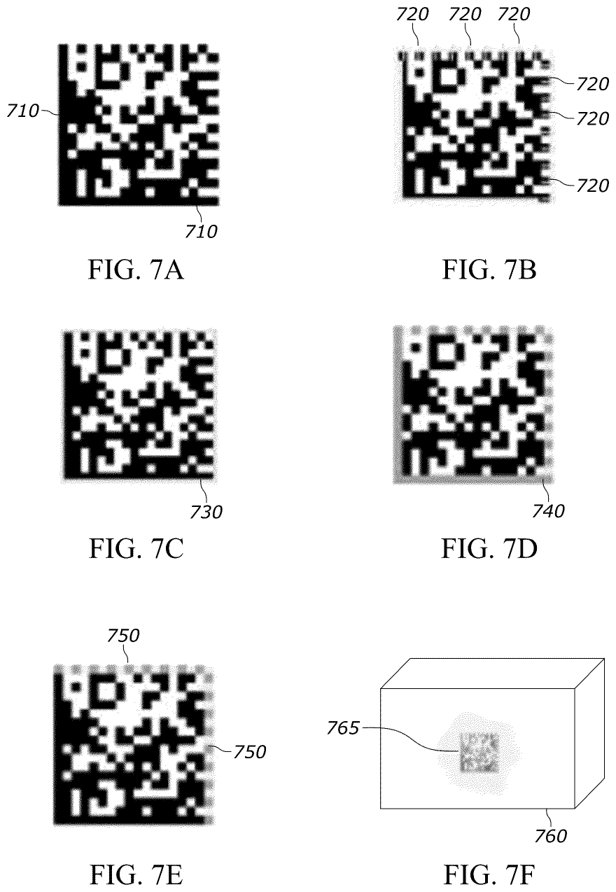

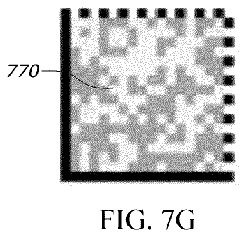

The confidence parameters may include one or more of, without limitation, a finder score, an alignment score, a shape score, a fixture score, a timing score, a texture score, and a decode score. The finder score may be a value indicative of the ability of the system in identifying and finding indicia in images. FIG. 7A-7G are images of an example indicia, as a data matrix code, illustrating various elements of the indicia for determining confidence parameters as described below. For example, the finder score may be a value between 0 and 1 with 1 being a high ability and efficiency of finding the indicia, while a score of 0 indicates that the system is not able to, took a long time to, or had to perform additional processes to find an indicia. FIG. 7A presents an image of an indicia, being a data matrix code, with an indication of a code candidate being the upper and right sides of the data matrix code. The full black line top and right-side edges are determined as indications of the candidate indicia and assist in locating the indicia in an image. The finder score may be determined by the consistency of the top and right borders 710, and the ability to detect such borders. The finder score may be equal to 1 for borders with no discontinuities, and may decrease with more discontinuities in the borders. The finder score may be calculated as FinderScore=k/(x+k), with x equal to the number of discontinuities, and k equal to a constant, which may be between 1 and 5. Additionally, the finder score may be determined as FinderScore=clamp((max_d−d)/max_d, 0, 1), with d being the distance between the detected and the expected ends of the edge, with max_d being the maximum such distance that still allows successful detection, and the clamp function acting to restrict output of the function between a minimum and maximum set value of 0 to 1. The top and right borders 710 of the data matrix code of FIG. 7A are one example of elements for identifying a candidate data matrix code for determining a finder score, and it should be understood, that other elements of a data matrix code, or other indicia, may be used. For example, for a QR code, the finder score may be determined by the consistency of borders of finder or position patterns (e.g., bull-eye patterns), with lower finder scores being assigned for edges and borders of patterns that are incomplete or broken. The finder score may be determined from the number of discontinuities of a border or pattern. An example finder score may be calculated as (4−y)/4 with y equal to the number of discontinuities, or calculated to be equal to k/(y+k) with y equal to the number of discontinuities, and k equal to a constant such as 3. Other equations for determining a finder score are envisioned.

The alignment score may be indicative of the ability of the system to perform distortions and image transformations to align an indicia for performing decoding of the indicia. For example, the alignment score may be greater for images with indicia that are able to be transformed and aligned to a respective template for a respective indicia. For example, the alignment score may be greater for indicia that allow for the alignment of corners, edges, and specific visual indicators of indicia as required for decoding a specific type of indicia (e.g., indicators on a QR code, alignment of bars in a barcode, etc.). A greater alignment score may be indicative of the ability to align indicia and transform images to align indicia according to desired configurations. For example, the alignment score may be greater for indicia that are able to be processed to have features within a specific margin of error of a template for a given indicia (e.g., edges, corners, indicators within a desired margin of error). The alignment score may decrease to 0 as edges, and features are further from the desired locations, or from a template arrangement of the indicia, for performing decoding. Series of individual elements of the indicia (e.g., edge points or elements of periodic patterns), and alignment portions (e.g., edges, corners, etc.) may individually be considered in determining an alignment for score an indicia. For example, an equilibrium-searching function may be used to combine the evaluation values of the alignment of various elements in determining the overall alignment score, while also allowing for ignoring individual elements featuring excessively low score. The equilibrium-searching function, as used herein, is to be understood to be a function that generates an overall score from a series of various different values or scores. The equilibrium-searching function may incorporate a weighted sum of individual scores, a geometric mean, a minimum of elements or other relationships such as exponential or inverse relationships between scores to generate an overall value or score. The equilibrium-searching function may include an option to remove one or several worst individual elements. With each individual element removed, the cumulative score may increase, while at the same time the overall score will be limited by the fact that some elements were removed. The type or form of the equilibrium-searching function may be dependent on a given score type (e.g., alignment score, shape score, etc.) and/or specific implementation or identifying and decoding of indicia.

In examples, the equilibrium-scoring function may be derived from a counting-based analysis for determining an overall confidence score, based on a series of individual elements, or “events”, eᵢ, each having an individual score sᵢ. For example, a counting-based score may be determined to be (m+1-n+k)/(m+1), with n being the maximum possible number of events, m being a margin of error (the maximum number of failing events that still allow for an overall success), and k the actual number of determined successes. The counting-based score is positive if and only if there are at least n-m successful events. The equilibrium-based scoring function may then be used and an overall confidence score may then be determined for example as max(min(sᵢ, (m+1-n+i)/(m+1))), with i ranging from 1 to k, with s₁ to sₖ being sorted in descending order.

The alignment score may be determined by first aligning outermost edges of an indicia, such as a data matrix code, with a fixed template for a finder pattern and/or timing pattern. The alignment score may then be determined as AlignmentScore=clamp((X-R+1)/(N-R+1), 0, 1) with N being the number of all fitting points (e.g., edge pixels and ticks of finder pattern and timing pattern), X being the number of fitting points that are correctly matched to an expected template, and R is a minimum number of fitting points that must be determined to perform an alignment, and the clamp function being a function that provides an output value of between 0 and 1. In another example, the alignment score may be determined as AlignmentScore=clamp((Max_D-D)/(Max_D-Suf_D), 0, 1) with D being the distance between fitted points and the points estimated positions from a template, Max_D is a maximum tolerable distance of the points from the expected positions, and Suf_D is a value of a sufficient distance that will still result in a score of 1, or of 100%. In additional examples, the alignment score may be determined for a QR code by precisely detecting the positions of alignment patterns, such as bulls-eye patterns, of a QR code. The alignment score may then be determined by AlignmentScore=clamp((Q-Min_Q)/(Suf_Q-Min_Q), 0, 1) with Q equal to the quality of each alignment pattern, Min_Q is a minimum tolerable quality value Q which may be 0.5, and Suf_Q is a sufficient quality value for a score of 1, or 100%, which may be 0.8. The value of Q, the quality of the pattern, may be determined by a normalized correlation of distances of edges of the alignment patterns (e.g., to the 1-1-3-1-1 pattern as a person of ordinary skill in the art would recognize), by a normalized correlation of pixel values, or by another method. FIG. 7B provides an image of a data matrix code with alignment elements 720 down the left and across the bottom sides of the data matrix code. The alignment score may be determined from the ability of the system to identify the alignment elements 720 in the example of FIG. 7B. The alignment score may further be determined by the quality of the alignment elements 720 in the image (e.g., resolution, contrast, spacing, etc.), or the amount of matching of the alignment elements 720 with an expect template of alignment elements for a given type of indicia.

The shape score may be indicative of the candidacy of an object in an image to be indicia, according to an expected shape of an indicia (e.g., square for QR code, rectangle for a barcode, single digit or character, rectangular grouping of an alphanumeric, etc.). The Shaping score can be a verification step to further evaluate the candidacy of portion of an image being indicia, after the indicia has been flagged by one or more indicia locating processes or image processing algorithms. The shape score may be based on one or more of the dimensions, angles, aspect ratio, lengths, and perspective factors of a candidate indicia in the image as compared to expected values for these features. The shape score may be determined by measuring side lengths, angles or slants of features, and/or proportions of various elements or features of the candidate indicia. In determining an overall shape score for an indicia, various elements that are not determined to match an expected shape or dimension are converted to soft inequalities. A soft inequality may be considered an extension of a hard inequality determination. An example of a soft inequality may be taken as clamp((b−a)/m, 0, 1), where “m” is a margin value being the minimal difference between a and b for the score to become 1. A hard inequality is an inequality determination that compares to values ‘a’ and ‘b’ and returns a high value (e.g., 1) is a is greater than b, or returns a low value (e.g., 0) is a is less than b. A soft inequality may be a comparison that returns a value with more resolution of a gradient of potential return values based on the comparison. For example, the resultant output of a soft inequality may be a value from 0 to 1 with a resolution or with increments of 0.1 (e.g., values of 0, 0.1, 0.2, 0.3, . . . 0.8, 0.9, 1). The output of the soft inequality being indicative of how great or small the values are in comparison. As such, the soft inequality provides an indication of a degree or amount of inequality, whereas a hard inequality simply provides a binary indication of greater or less than comparisons of values.

The shape score may be determined by taking the lengths of the sides of an indicia, such as a data matrix code, taking a slant value (e.g., deviation of adjacent sides from joining at a 90-degree angle), and proportions of a longer side to shorter side. The shape score may then be determined as ShapeScore=clamp((Max-X)/(Max-Suf), 0, 1) with Max being a maximum tolerable value of the given metric (e.g., length, slant, etc.), Suf being a sufficient value to result in a score of 1 or 100%, and X being a respective metric to be measured such as length, slant value, etc. In other examples, the shape score may be determined as ShapeScore=clamp((X-Min)/(Suf-Min), 0, 1) with Min being a minimum tolerable value of a given metric (e.g., length, slant value, size, etc.), and other methods for determining the shape score are envisioned. FIG. 7C provides an image of a data matrix code with the square border 730 of the data matrix code being illustrative of an overall shape of the data matrix code. The square border 730 is indicative of a high match with an expected shape of the data matrix code for determining the shape score.

The fixture score may be indicative of a specific fixed pattern that is used to identify the presence of a code portion of the indicia. For example, the code portion may be binary graphical elements (e.g., binary pixels in a QR code, lines in a barcode), or symbols such as digits and characters in an alphanumeric code or serial code. A high fixture score is indicative of a high likelihood that code exists in the identified indicia, and a low fixture score is reduced or low likelihood that a code portion exists. The fixture score may be determined as a ratio of foreground to background pixels in an indicia. As used herein, a foreground pixel may be considered to be a darker or black pixel, while a background pixel may be considered to be a lighter or white pixel. The foreground and background pixels may be determined by a darkness or brightness value threshold, or a contrast between adjacent regions or pixels, or by another means. A region with a specific layout of foreground and background pixels indicates a higher likelihood of a barcode or indicia (e.g., QR code, data matrix code) in a region of an image.

Additionally, a series of foreground pixels may be indicative of an identifier (e.g., pattern to identify the presence of a data matrix code, barcode) that is indicative of a type of barcode or indicia. The regions of foreground pixels indicative of indicia may be referred to as finder patterns, and background pixels, or nearly background pixels, may indicate a quiet zone, or discontinuities or defects in a potential finder pattern. The fixture score may be determined by how closely a region of pixels or modules matches an expected template, such as a bulls-eye finder pattern for a QR code. The bulls eye finder pattern has a given ratio of foreground to background pixels, and the finder score may be indicative of how closely a region matches the expected ratio for the bulls-eye pattern, or for another expected pattern (e.g., timing patter, other finder patterns, etc.). Additionally, the fixture score may be used to determine a correct rotation of an indicia based on elements such as finder patterns, timing patterns etc.

The fixture score may be determined as a weighted sum of foreground and background pixels, or may be determined by another comparison of totals of foreground and background pixels. In other examples, the fixture score may be determined based on pixels, or on entire modules in a barcode or indicia. Described herein, a module may be considered to be the smallest unit such as a single bar for a barcode, or 2D box in a QR code that may be used to encode information (e.g., 1 or 0 based on foreground or background/light or dark) in indicia. In a specific example, for a QR code, the fixture score may be determined using a normalized cross correlation between an obtained image of a QR code, and an expected QR code pattern or finder pattern. This may be useful for determining whether a bulls-eye pattern, or other finder pattern, is present in the image, which may further be used to determine the presence of indicia such as a barcode. Fixture scores may further be determined from other methods such as linear scans, correlations, and frequency-based analysis. FIG. 7D is an example data matrix code with the border 740 indicated for determining the fixture score. The border 740 includes both foreground and background pixels that are taken into consideration, for the given example, for determining the fixture score. In other examples, such as a QR code, different regions that contain a potential bulls-eye finder pattern may be taken into consideration when determining a fixture score.

The timing score may be indicative of a timing code or clocking pattern for an indicia. The timing score may be determined from the number of ticks of a timing pattern, and respective qualities of the ticks. As described herein, the timing code may be understood to be graphical patterns as series of alternating dark and light modules, or different colored pixels or modules, of an indicia (e.g., lines of a barcode, square pixel elements of a QR code). The ticks of the timing code may be understood to be the individual pixels, lines, modules, or graphical elements that make up the timing code (e.g., the pixel elements in the rows and columns of a QR code). The timing code and patterns assist in determining how as system scans the various rows and columns of an indicia for de-coding indicia (e.g., determines the points at which the module grid is sampled) which facilitates a correct interpretation and de-coding of an indicia such as a QR code of data matrix. The timing score may be determined as the system's ability to properly identify and interpret the timing code. Additionally, the timing score may be determined from a length of a timing code, number of ticks, and/or quality of individual ticks (e.g., shape, contrast, resolution, etc.). To determine the timing score, individual ticks may be identified and evaluated. A score for the quality of each tick is then determined and the individual scores for the ticks may be combined to generate an overall timing score. The individual scores for the ticks may be combined using an equilibrium-searching function or method. The score for each tick may be determined by a contrast or definition of the edges of the ticks. An edge detection algorithm may be used to further evaluate and generate individual scores for the ticks of the timing code. A high score indicates a high or strong edge of a tick, and a low score is indicative of a low contrast or weak edge of a tick. The timing score may require a minimum number of ticks for determining a timing score, and a value of 0 may be assigned to the timing score for indicia that are determined to have fewer than the minimum required detectable ticks. FIG. 7E presents an image of a data matrix code with left and bottom edges 750 indicated as parts of the data matrix code with a timing pattern or timing code. The timing code is indicated by the bright and dark pixels or modules of the edges of the data matrix code. The timing score may be determined by a match of the pattern of the imaged data matrix code with an expected timing pattern, and/or the quality of the ticks of the timing code.

The texture score may be indicative of an area of contrast, or different texture, than other parts of an image. The texture score may be used for identifying potential indicia in images as the indicia may be printed on a part, or result in a different texture or notably different pattern as compared to the rest of an object or image. The texture score may be determined by calculating one or more gradients across an image and identifying regions with sharp changes in contrast, color, brightness, or another image parameter. Additionally., various types of gradients may be used in determining the texture score including, without limitation, a Sobel gradient, Prewitt gradient, Scharr gradient, or determining a gradient from various differences in an image from one or more image-based parameters or values. The texture score may be determined according to histograms of gradients in each direction for each pixel, and a series of pixels with high gradient values may be determined as a region, or border of a region, with a high texture score, which may be indicative of an indicia in the image. The high texture scores may be determined as regions of the image with gradient values above a certain threshold. A high texture score may be determined to indicate a high likelihood of indicia in a region of an image, and a low texture score may indicate low likelihood of indicia to be in a region of an image. In additional examples, the gradient score may be determined from identifying minimum and maximum pixel image values (e.g., brightness values, color values, etc.) and determining regions of the image where the differences between adjacent values is greater than a threshold value. FIG. 7F provides an image of an object 760 having a data matrix code thereon. The image of FIG. 7F shows a region 765 determined as having a high likelihood of containing the indicia as identified using the texture score described herein.

The decode score may be determined from the ability of the system to binarize the indicia, and further decode the indicia with any error correction. A lower decode score may indicate an indicia that required more error correction for decoding the indicia. The decode score may further depend on soft inequality determinations for each module of an indicia. For example, each module may be determined as a 1 or 0 depending on whether a brightness of the module is above or below a given threshold. The soft inequality values may be determined for each module based on how far above or below the module is from the threshold value, and the soft inequality values may then be used to determine the overall decode score. Modules with greater contrast overall result in a higher decode score, while indicia with less brightness or contrast different between modules results in a lower decode score as there is less differentiation between foreground and background modules. The decode score may be determined from an amount of time required to decode the indicia, or may be set to 0 or a negative value if the indicia is unable to be decoded. In one example, the decode score may be derived from a ratio of the available error correction bits to the total used error correction bits. Additionally, the decode score may be determined from evaluations of individual modules of the code. A module may be considered to be a single black or white cell inside of the code of the indicia. Modules, in the provided illustrations are square, but may take on other shapes (e.g., circles, lines, etc.). A confidence score may be calculated, using a soft inequality, for each individual module of the code portion as the soft thresholding may be performed for each module separately. For example, the confidence score for each individual module may be taken as (0.5−|y−x|)/0.5, with ‘x’ being the result of a soft inequality, with values ranging from 0 indicating a sure background module, to 1 indicating a sure foreground module. The value ‘y’ is then the expected ideal value (0 or 1) and the confidence values for the modules becomes 1 when y=x, and becomes 0 whenever x=0.5, which is in the middle of the thresholding range. An overall decode score may then be determined for a respective indicia from the determined error correction score and scores of the individual modules of the indicia. The equilibrium-searching function may be employed to determine the overall score when some low-score individual modules should be ignored. FIG. 7G provides an image of a data matrix code with central region 770 indicative of code of the data matrix code include a plurality of modules (e.g., rows and columns of square pixels in the provided example), for decoding, and further for determining the decode score.

Any of the described confidence parameters described herein may take on values, inclusively, from 0 to 1. Additionally, the confidence parameter values may be determined to have different scales, and be other values based on specific use cases, system implementations, types of barcodes, etc. As should be understood, the confidence parameter values may independently be determined to be any value that may be used to further generate a confidence rating for evaluating the ability of an imaging system to image, identify, and decode indicia.

At 612, the processor further determines a confidence rating from the one or more determined confidence parameters. The confidence rating is indicative of the system's ability to identify and decode indicia in an image. As such, the system may determine a confidence rating for each respective image, or for individual indicia within each image. The confidence rating may be determined by combining one or more of the values of the scores of the confidence parameters. In examples, the confidence rating may be indicative of how well or how efficient a system is at identifying and decoding an indicia. For example, the confidence rating may be determined as a value between 0 and 1 with 0 being a low confidence, and 1 being a high confidence of the system's capability to decode an indicia. A confidence rating closer to 0 is indicative that the system has more trouble, or is unlikely to decode the indicia, while a confidence rating closer to 1 indicates high quality of an imaged indicia, and high likelihood of success, and efficient decoding of the indicia. A confidence rating of 0 may indicate that the system is uncapable of decoding an indicia.

The confidence rating may further include negative values. A negative value confidence rating may indicate that the system is unable to decode an indicia, or a no-read state. A more negative value (i.e., greater absolute value) indicates a greater distance of the system from being able to decode the value. For example, a confidence rating of −0.5 may indicate that a few imaging parameters need to be adjusted, that an image needs more processing, or that the system requires more time to identify and decode an indicia. Whereas a confidence rating of-2 might indicate that the system needs additional optimization or tuning or even greater adjustments such as increased illumination in an environment, or that a barcode is ripped and cannot be identified even with additional tuning of parameters. In examples, a negative confidence rating may result from confidence parameter scores that are not limited to a scale of 0 to 1, and may include negative values. Additionally, negative confidence ratings may indicate that the imaging, pre-decoding, and/or decoding parameters of the system must be relaxed or expanded to increase the confidence rating to decode indicia, which may further result in increased time require for performing the imaging, pre-decoding, and decoding of the indicia.

The confidence rating may be determined by a summation and normalization of the values and scores of the confidence parameters. For example, the confidence rating may be determined to be a summation of all of the confidence parameter values, or may additionally divide the summation of the confidence parameter values by a maximum potential sum of the confidence parameter values. Additionally, the overall confidence rating may be determined to be the lowest score, or minimum score of the confidence parameter values. As such, the confidence score takes on the lowest value or weakest performing confidence parameter which may be further used to tune system parameters to focus on increasing the lowest parameter in a first iteration, and may be further re-evaluated and used to further tune parameters to increase lowest scoring confidence parameter values in subsequent iterations. Furthermore, the overall confidence rating may be determined by applying the soft-min function that assigns low overall scores based on the minimum individual score, but also takes into account other values, so that the final value does not simply copy the value of the minimal individual score. In one example, this soft-min function may be implemented using the following formula: soft-min(x)=0.9*minimum(x)+0.1*product(x), where ‘x’ is an array or list of values corresponding to the individual score values (e.g., fixture score, decode score, etc.), minimum(x) returns the lowest of the score values, and product(x) is a function that multiples all values of ‘x’ together.

At 614 the method 600 includes tuning one or more parameters of the system according to the determined confidence rating. The system may determine, from the confidence rating, that an image needs to be further processed for an indicia to be decoded, or to more efficiently decode indicia in a given environment. As such, the system may tune one or more of the image processing parameters to increase the confidence rating in subsequent obtained images. Additionally, the system may tune one or more of the image processing parameters for a current image, which may further improve the performance of performing decoding, and increase the confidence rating, or subsequently obtained images. Further, a processor may determine that an indicia needs to be imaged at a different angle and may provide feedback to a user to move a scanner to obtain an image at a field viewing angle of the indicia. In examples, the processor may tune a parameter of one or more of an imaging parameter of an imaging device (e.g., imaging resolution, imaging contrast, frame rate, capture exposure time, focus, image gain, etc.), an illumination parameter of one or more sources of illumination (e.g., color of illumination, brightness of illumination, flash period, etc.), an image processing parameter (e.g., image morphology parameters, image smoothing strength, threshold for determining foreground/background pixels or modules, pyramid height a pre-decoding parameter of a pre-decoding algorithm or module (e.g., an image processing parameter, a skew amount, a contrast change, a brightness change, an amount of skew, an amount of resize, etc.), and a parameter of a decoding algorithm or module (e.g., a number of allowable module errors, a required PPM, a decode rate, a decode time-out, etc.). The processor may further tune one or more of a contrast threshold (e.g., grey level difference between foreground/dark and background/light modules), contrast perturbations (e.g., a number of applied perturbations to the contrast threshold for detecting when light conditions are variable), detection method (e.g., a specification of a particular finder pattern, blob of a quiet zone, and/or code type for detection), pyramid strategy (e.g., the step of image downscaling for finding codes at different scales or sizes), outline strategy (e.g., a specification of the level of precision of outline detection), finder tradeoff (e.g., an indication of whether to optimize parameters for indicia with weak edges or with rough edges), edge tracker (e.g., an indication of how strongly an edge tracker preserves the continuity of an edge of an indicia), resolution level (e.g., an indication of the level of image-upscaling in resolution which may be required for low resolution images to produce higher resolution images of indicia), polarity (e.g., an indication of whether code is darker or brighter than image background), minimum and/or maximum module row count (e.g., a minimum and maximum amount of expected or allowed module rows), minimum and/or maximum module column count (e.g., a minimum and maximum amount of expected or allowed module columns), minimum and/or maximum module size (e.g., a minimum and maximum of expected or allowed module size in pixels or spatial dimensions), expected gap size (e.g., the highest distance between neighboring marks in a finder pattern), maximum rectangle ratio (e.g., the ratio between the length of the a longer side to a shorter side of a codes bounding rectangle), maximum slant (e.g., the maximum deviation of an indicia, or a bounding rectangle of an indicia, from a right angle as determined by a finder pattern), perspective distortion parameter (e.g., an indication of an amount of allowed perspective distortion), oversize module parameter (e.g., a parameter indicative of an allowed amount of overlapping modules in an indicia), rotation parameter (e.g., an indication of an allowed amount of rotation of an indicia in an image), distortion parameter (e.g., an indication of an allowed amount of image distortion), broken timing parameter (e.g., an indication of whether an attempt to decode indicia with broken timing code is allowed), broken finder parameter (e.g., an indication of whether an attempt to identify and/or decode an indicia should be made with a finder pattern with gaps or errors), broken corner parameter (e.g., an indication of whether an attempt to identify and decode indicia with one or more occluded corners is be allowed), and mirroring parameter (e.g., an indication of whether indicia are allowed to be mirror or transposed). Additionally, the tuning may include providing feedback to a user for the user to perform one or more physical changes to a system such as provide additional light, move an imaging device, move a target object or indicia, etc.

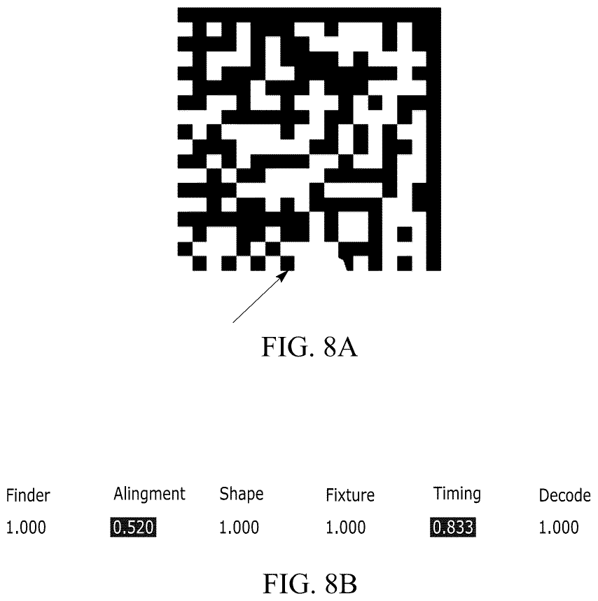

FIG. 8A is an image of a data matrix code for determining a confidence rating according to embodiments described herein, and FIGI. 8B presents a table of scores for different confidence parameters for the data matrix code of FIG. 8A. Each of the finder score, shape score, fixture score, and decode score have a value of 1 indicating high confidence and performance for each of the respective image processing, pre-decoding, and decoding processes associated with each respective score. The alignment score had a value of 0.520 and the timing score had a value of 0.833. The image of the indicia had one timing pattern tick that was not captured, as shown by the arrow in FIG. 8A, which causes a reduced timing score, and further, reduces the alignment score as the timing pattern is used, in the current example, to further properly align the data matrix code for performing decoding. As described above, the overall confidence rating may be taken as a combination of the various confidence parameter values, or the confidence rating may be taken as the lowest confidence parameter value among the confidence parameters. Taking the lowest confidence parameter value as the confidence rating allows for focusing tuning of the system to increase the weakest performing confidence parameter. In examples, the system may determine, from the values of the confidence parameters of FIG. 8A, that additional images of the indicia should be obtained at different illuminations to improve the confidence rating and confidence parameter scores. In other examples, the system may determine from the confidence rating and confidence parameter scores that the data matrix code is misprinted, and that the data matrix code is missing a tick, and that no tuning of the system may be performed that will increase the confidence rating and associated confidence parameter scores.

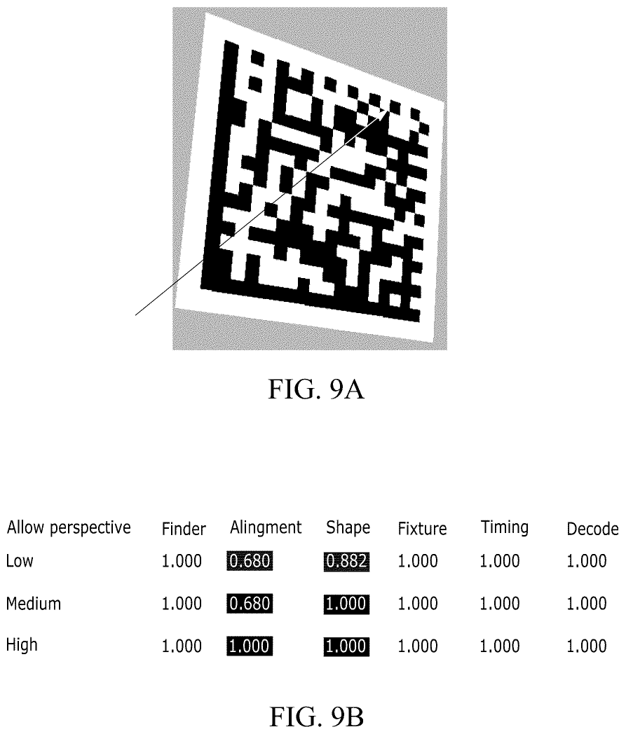

FIG. 9A is an image of a data matrix code for determining a confidence rating according to embodiments described herein, and FIG. 9B presents a table of scores for different confidence parameters for the data matrix code of FIG. 9A. The table of FIG. 9A presents three rows of scores with each row representing a first, and subsequent image processing/pre-decode processing iterations of the image of FIG. 9B. Each of the finder, fixture, timing, and decode scores have values of 1 indicating that the associated evaluations for the respective processes were performed with high confidence. The first iteration of processing resulted in alignment and shape scores below 1. In the first iteration, the system was set to perform minimal image transformation, and specifically, minimal changes to image perspective to reduce the overall processing and decoding time. As a result, the image of the indicia was not transformed enough to allow for high confidence in the post-processed shape, and alignment of the indicia as compared to an expected shape and alignment for the data matrix code. The second row performed the pre-decode processing with a medium amount of image perspective change and transformation, and the third row was performed with high perspective and image transformation. The system was able to achieve alignment and shape scores of 1 with the increased amount of time and processing allowed for image transformation. Tuning the amount of allowed perspective and image transformation is one example of tuning a system parameter based on determined confidence ratings and confidence parameter scores, to increaser the confidence parameter scores and an associated confidence rating. The increased dependence on image and perspective transformation could be expected from the example image of FIG. 9A, as the data matrix code has a skew and rotation required to change the perspective to a more direct view of the data matrix code, and to rotate the QR code to a proper orientation for decoding.

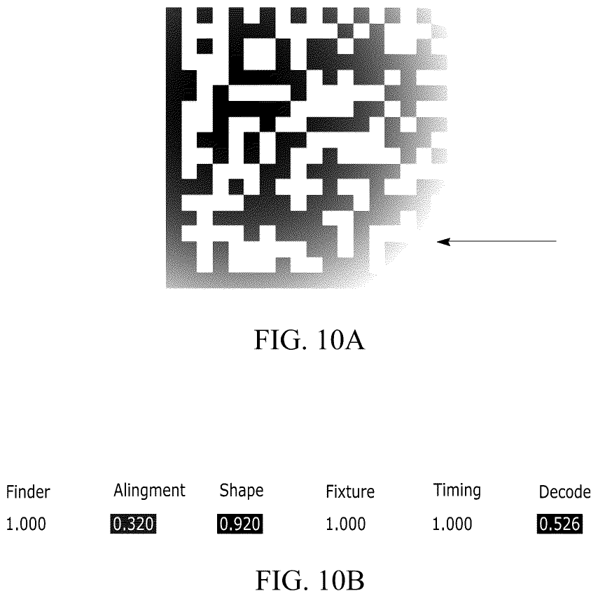

FIG. 10A is an image of a data matrix code for determining a confidence rating according to embodiments described herein, and FIG. 10B presents a table of scores for different confidence parameters for the data matrix code of FIG. 10A. Each of the finder, fixture, and timing scores resulted in high confidence values of 1, while the alignment, shape, and decode scores were less than 1. Similar to the example image of FIG. 9A, the data matrix code of FIG. 10A is captured at a skewed angle, and not from perspective directly in front of the data matrix code. The system was set to perform minimal perspective and image transformations which resulted in the reduced shape and alignment scores. Additionally, the image includes a region of overexposure, denoted by the arrow in FIG. 10A, which causes mistakes in binarization of the barcode resulting in a reduced decode score. In response to the determined confidence parameters of FIG. 10B, the system may further tune parameters to reduce the amount of provided illumination to reduce the region of overexposure, and increase the allotted processing and time for image processing which could further improve the shape and alignment scores.

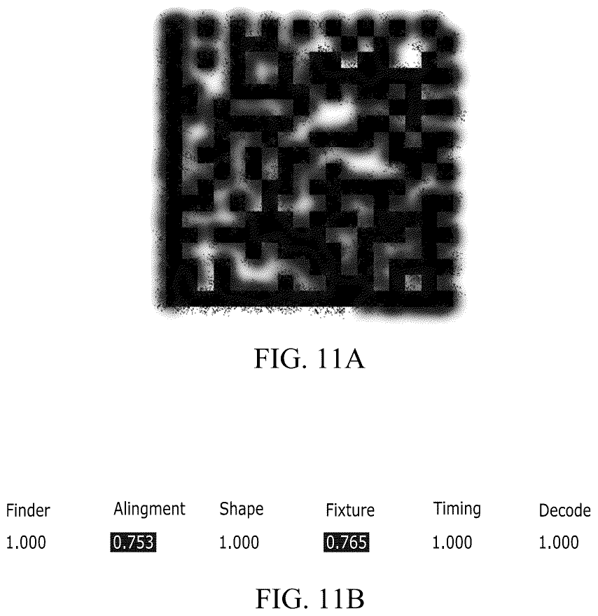

FIG. 11A is an image of a data matrix code for determining a confidence rating according to embodiments described herein, and FIG. 11B presents a table of scores for different confidence parameters for the data matrix code of FIG. 11A. Each of the finder, shape, timing, and decode scores resulted in high confidence values of 1, while the alignment and fixture values were less than 1. The image of the barcode in FIG. 11A includes increased background noise which reduces the contrast between various edges resulting in the reduced fixture score. The noisy image combined with a narrow quiet zone also causes the system to not be able to fully reliably perform alignment. The system may determine, from the confidence parameter scores of FIG. 11B, to obtain additional images at different focuses, exposures, or illumination brightness to obtain higher contrast images of the data matrix code to improve the independent confidence parameter scores and overall confidence rating.

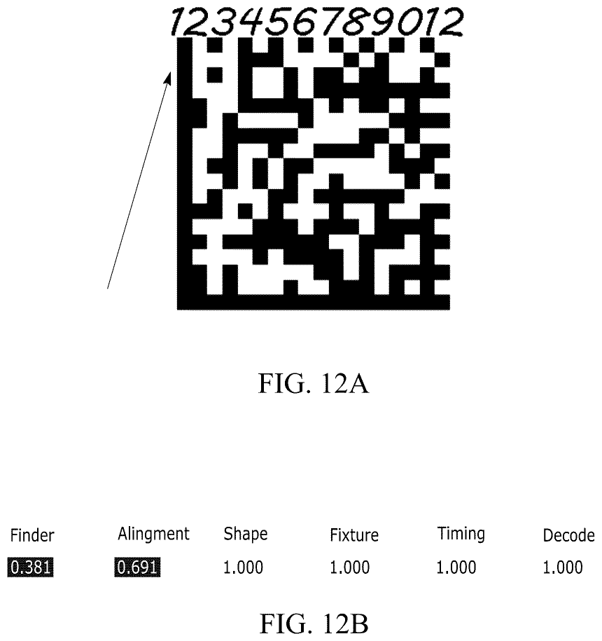

FIG. 12A is an image of a data matrix code for determining a confidence rating according to embodiments described herein, and FIG. 12B presents a table of scores for different confidence parameters for the data matrix code of FIG. 12A. Each of the shape, fixture, timing, and decode scores result in high confidence values of 1, while the finder and alignment scores are both less than 1. The finder score is reduced due to the system being unable to identify the edge of the data matrix code in the region indicated by the arrow in FIG. 12A. The bottom portion of the “2” above the data matrix code causes the system to detect a false edge to the data matrix code resulting in the system not properly identifying the boundaries of the data matrix code. This erroneous edge location causes the reduced finder score. Additionally, since the data matrix code edge is incorrect, the alignment score is reduced as the data matrix code cannot be properly fit to an expected data matrix code alignment if the imaged data matrix code size and dimensions are incorrectly identified. In examples, the system may determine that another data matrix code identifying process or algorithm may be used to improve determining the location of the data matrix code in the image, which may improve the overall confidence rating.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Alternative implementations of the examples represented by the block diagram of the system 200 of FIG. 2 includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware, computer-executable instructions) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A computer-implemented method for performing confidence scoring of an imaging system, the method comprising:
obtaining, by the imaging system, an image of a field of view of the imaging system, the image including an indicia;
identifying, by a processor, the indicia in the image;
decoding, by the processor, the indicia;
determining, by the processor, one or more confidence parameters from at least one of (i) the image of the indicia, and (ii) the decoding of the indicia;
determining, by the processor, a confidence rating from the one or more confidence parameters.

2. The method of claim 1, wherein the confidence score comprises values from 0 to 1, with a value of 1 being indicative of high confidence, and a value of 0 being indicative of low confidence.

3. The method of claim 1, wherein the confidence score comprises a negative value indicative of a no read state wherein the system is incapable of decoding the indicia.

4. The method of claim 3, wherein an absolute value of the negative value is indicative of a distance of the system from reading the indicia.

5. The method of claim 1, wherein the confidence parameters include one or more of a finder score, an alignment score, a shape score, a fixture score, a timing score, a texture score, and a decode score.

6. The method of claim 1, further comprising tuning one or more parameters of the system according to the determined confidence parameter.

7. The method of claim 6, wherein the one or more parameters of the system comprises at least one of an imaging parameter of the imaging system, an illumination parameter, a pre-decoding module parameter, and a decoding parameter.

8. The method of claim 6, wherein the one or more parameters includes at least one of an imaging resolution, an image capture rate, an image capture exposure time, an image gain, an illumination brightness, a decode rate, a decode time-out, a contrast threshold, contrast perturbations, detection method, pyramid strategy, outline strategy, finder tradeoff, edge tracker, resolution level, polarity, module row count, minimum and/or maximum module row count, minimum and/or maximum module column count, minimum and/or maximum module size, expected gap size, maximum rectangle ration, maximum slant, perspective distortion parameter, oversize module parameter, rotation parameter, distortion parameter, broken timing parameter, broken finder parameter, broken corner parameter, and mirroring parameter.

9. The method of claim 1, wherein the indicia includes one or more of a QR code, a barcode, a 2D barcode, a 1D barcode, a UPC code, an alphanumeric code, and a serial number.

10. A system comprising:
an imaging assembly having an imaging sensor configured to capture images of a field of view of the imaging assembly;
one or more processors and machine-readable instructions that when executed by the one or more processors cause the system to:
obtain, by the imaging system, an image of a field of view of the imaging system, the image including an indicia;
identify, by a processor, the indicia in the image;
decode, by the processor, the indicia;
determine, by the processor, one or more confidence parameters from at least one of (i) the image of the indicia, and (ii) the decoding of the indicia;
determine, by the processor, a confidence rating from the one or more confidence parameters.

11. The system of claim 10, wherein the confidence rating comprises values from 0 to 1, with a value of 1 being indicative of high confidence, and a value of 0 being indicative of low confidence.

12. The system of claim 10, wherein the confidence rating comprises a negative value indicative of a no read state wherein the system is incapable of decoding the indicia.

13. The system of claim 12, wherein an absolute value of the negative value is indicative of a distance of the system from reading the indicia.

14. The system of claim 10, wherein the confidence parameters include one or more of a finder score, an alignment score, a shape score, a fixture score, a timing score, a texture score, and a decode score.

15. The system of claim 10, wherein the machine-readable instructions further cause the system to tune one or more parameters of the system according to the determined confidence parameter.

16. The system of claim 15, wherein the one or more parameters of the system comprises at least one of an imaging parameter of the imaging system, an illumination parameter, a pre-decoding parameter, and a decoding parameter.

17. The system of claim 15, wherein the one or more parameters includes at least one of an imaging resolution, an image capture rate, an image capture exposure time, an image gain, an illumination brightness, a decode rate, a decode time-out, a contrast threshold, contrast perturbations, detection method, pyramid strategy, outline strategy, finder tradeoff, edge tracker, resolution level, polarity, module row count, minimum and/or maximum module row count, minimum and/or maximum module column count, minimum and/or maximum module size, expected gap size, maximum rectangle ration, maximum slant, perspective distortion parameter, oversize module parameter, rotation parameter, distortion parameter, broken timing parameter, broken finder parameter, broken corner parameter, and mirroring parameter.

18. The system of claim 10, wherein the indicia includes one or more of a QR code, a barcode, a 2D barcode, a 1D barcode, a UPC code, an alphanumeric code, and a serial number.

19. One or more non-transitory computer-readable media storing computer-executable instructions that, when executed via one or more processors, cause one or more systems to:
obtain an image of a field of view of the imaging system, the image including an indicia;
identify the indicia in the image;
decode the indicia;
determine one or more confidence parameters from at least one of (i) the image of the indicia, and (ii) the decoding of the indicia;
determine a confidence rating from the one or more confidence parameters.
